(19) United States
(12) Patent Application Publication
(10) Pub. No.: US 2003/0193554 A1
(43) Pub. Date: Oct. 16, 2003

(54) Aqueous colorant preparation for inkjet printing

(76) Inventors: James Bullock, Schriesheim (DE); Michael Krapp, Altrip (DE); Karl Siemensmeyer, Frankenthal (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/362,365

(22) PCT Filed: Aug. 30, 2001
(86) PCT No.: PCT/EP01/10042

(30) Foreign Application Priority Data
Aug. 31, 2000 (DE) 11 42 900.9

(51) Int. Cl. G01D 11/00

(52) U.S. Cl. 347/100

(57) ABSTRACT

The use is described of an aqueous colorant preparation including colloidally dispersed colorant particles and at least one dispersant selected from sulfonated and/or sulfomethylated lignins having a weight average molecular weight of not less than 25000 wherein more than 50% by weight of the lignins have a molecular weight of more than 10000, for printing sheetlike substrates by means of inkjet printing.

### DESCRIPTION

This invention relates to the use of an aqueous colorant preparation including colloidally dispersed colorant particles and a dispersant for printing sheetlike substrates by means of inkjet printing.

In inkjet printing, typically aqueous inks are uniformly pressed through a nozzle in small droplets and sprayed directly onto the substrate. Inks used in the inkjet printing process have to meet a whole series of requirements. They have to have a viscosity and surface tension suitable for printing, they have to be stable on storage, ie. they should not coagulate and the dispersed colorant should not sediment, and they must not clog up the printer nozzle.

Inks based on dispersed colorants (eg. pigments, disperse dyes and vat dyes) for inkjet printing, ie. inkjet inks, are generally produced in a two-step process. In the first step, the colorant is ground with a dispersant and optionally further assistants in a high-speed mill to produce a paste. In the second step, the ink is produced by diluting the paste with water and optionally further customary assistants.

Owing to the special requirements of inkjet inks, dispersants that are recommended for preparing dyeing liquors for yarn or piece dyeing are not necessarily suitable for producing inkjet inks.

DE 197 27 766 concerns pigment preparations for the inkjet process which include a finely divided pigment and a dispersant based on arylsulfonic acid-formaldehyde condensation products or on alkoxylated phenols.

It has been determined that the conjoint grinding of a colorant with a dispersant in a high speed mill frequently produces highly viscous and/or thixotropic pastes. In these cases, a colorant particle size sufficiently small for an inkjet ink is obtained only after very prolonged grinding, if at all. An ink produced from these highly viscous or thixotropic pastes exhibits poor performance characteristics in inkjet printing. Frequently the colorant particles tend to agglomerate after grinding or in the ink, which may be ascertained, for example, from significant residues being left behind on a finely meshed sieve used for filtering the ink.

EP 0 829 524 A describes a dispersant which is selected from the group consisting of sulfonated lignin and sulfomethylated lignin and which is essentially free of molecules below a molecular weight of 3000; a colorant composition including said dispersant;

and the use of said colorant composition for coloring natural and synthetic fibers. The use of the colorant composition for inkjet printing is neither described nor suggested.

It is an object of the present invention to provide aqueous colorant preparations which are very useful for printing sheetlike substrates by means of inkjet printing and whose production does not present the problems described above.

We have found that this object is achieved by the use of an aqueous colorant preparation including colloidally dispersed colorant particles and at least one dispersant selected from sulfonated and/or sulfomethylated lignins having a weight average molecular weight of not less than 25000 wherein more than 50% by weight of the lignins have a molecules weight of more than 10000, for printing sheetlike substrates by means of inkjet printing.

The invention also provides a method of producing a colorant preparation, which comprises grinding a colorant in the presence of a dispersant selected from sulfonated and/or sulfomethylated lignins having a weight average molecular weight of at least 25000 wherein more than 50% by weight of the molecules have a molecular weight of more than 10000 to form a millbase including colorant particles having a median particle size of less than 1 μm and diluting the millbase with water to form a colorant preparation having a colorant content of from 0.1 to 20% by weight.

The invention also provides an aqueous colorant preparation useful for inkjet printing, including colloidally dispersed colorant particles having a median particle size of less than 1 μm and at least one dispersant selected from sulfonated and/or sulfomethylated lignins having a weight average molecular weight of not less than 25000 wherein more than 50% by weight of the molecules have a molecular weight of more than 10000.

Preferably the dispersant is selected from sulfonated and/or sulfomethylated lignins having a weight average molecular weight of more than 26000, for example in the range from 26000 to 35000, and preferably more than 54% by weight of the molecules have a molecular weight of more than 10000. The polydispersity index PDI, which is defined as the ratio of the weight average molecular weight to the number average molecular weight, is preferably in the range from 7 to 11, especially from 8 to 10.

The degree of sulfonation/sulfomethylation (% by weight of sulfonic acid groups) is preferably in the range from 4 to 6.

Useful dispersants from the class of the sulfonated and/or sulfomethylated lignins are readily identifiable by reference to their molecular weight distribution. The molecular weight distribution is advantageously determined by gel permeation chromatography with UV detection. Suitable gel permeation chromatography columns include for example HEMA Bio from Polymer Standards GmbH, Mainz, having porosities of 40, 100 and 1000 Å. A suitable mobile phase is a mixture of 60% by weight of 1 M aqueous sodium nitrate solution, 30% by weight of tetrahydrofuran and 10% by weight of acetonitrile. The system is advantageously calibrated with polystyrenesulfonates (sodium salt form) of known molecular weight.

By plotting the weight fraction of molecules of a molecular weight class against the molecular weight and integrating it is possible to determine the fraction of molecules having a molecular weight of more than 10000.

Lignin is an amorphous phenylpropane polymer occurring in conjunction with the cell wall polysaccharides of many plants. To prepare the dispersant used in the invention, it is convenient to start with lignins which are recovered on a large industrial scale by means of wood pulping processes known to those skilled in the art, for example the sulfite process, the kraft process, the soda process, etc. In the kraft process, wood chips are subjected to pulping in a strong alkaline medium in which the natural lignin polymers are degraded into fragments having a broad spectrum of various molecular weights. The lignins produced in this process form soluble alkali metal salts which dissolve in the pulping liquor and can thus be separated from the cellulose. The lignins are precipitated in the pulping liquor by lowering the pH, which converts the phenolate groups of the lignin molecules into their free phenol form. The lignins obtained in the kraft process may be sulfonated and/or sulfomethylated in a further operation. Sulfonation is suitably carried out by treatment with sulfites or bisulfites. Sulfomethylation is effected by reacting the lignin with sulfite and formaldehyde, for example as described in U.S. Pat. No. 2,680,113.

In sulfite pulping, wood chips are cooked with solutions of bisulfites or sulfites. Depending on whether bisulfite solutions additionally contain sulfur dioxide or not, the processes are referred to as acidic bisulfite processes or only as bisulfite processes. In sulfite pulping, the lignin is sulfonated, hydrolyzed and dissolved as sulfonated lignin. It can then be recovered by acidification, coagulation and filtration or decanting and, if necessary, further sulfonated and/or sulfomethylated to increase the solubility.

The sulfonated and/or sulfomethylated lignins obtained by the above processes generally have a broad molecular weight distribution. Before they can be used to produce the colorant preparation used according to the invention, it is generally necessary to remove low molecular weight fractions therefrom. The method used to remove the low molecular weight fractions is not critical. However, particular preference is given to the process of ultrafiltration through an ultrafiltration membrane having an exclusion limit of 3000, preferably 10000. Alternatively, reverse osmosis is also suitable for removing low molecular weight fractions.

It is also possible for the lignins obtained by wood pulping to be subjected to a treatment to remove low molecular weight fractions and subsequently to be sulfonated and/or sulfomethylated.

Lignin dispersants useful for the present purposes are commercially available from Westvaco Corporation under the name HyAct. The production of suitable lignin dispersant is described in EP 0 829 524.

As well as the lignin dispersant, the aqueous colorant preparation includes colloidally dispersed colorant particles. The colorants are selected from organic or inorganic pigments or preferably disperse dyes. Organic pigments as used herein also comprehend vat dyes. The preferred disperse dyes are selected from water-insoluble or sparingly water-soluble azo, anthraquinone, quinophthalone, methine and azamethine dyes. The following are particularly suitable:

C. I. Disperse Yellow 1, 2, 3, 4, 5, 6, 7, 8, 9, 10, 11, 11:1, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 179, 180, 181, 182, 183, 184, 184:1, 200, 201, 202, 203, 204, 205, 206, 207, 208, 209, 210, 211, 212, 213, 214, 215, 216, 217, 218, 219, 220, 221, 222, 223, 224, 225, 226, 227, 228.

C. I. Disperse Orange 1, 2, 3, 3:3, 4, 5, 6, 7, 8, 9, 10, 11, 12, 13, 14, 15, 16, 17, 18,19, 20, 21, 22, 23, 24, 25, 25:1, 26, 27, 28, 29, 30, 31, 32, 33, 34, 35, 36, 37, 38, 39, 40, 41, 41:1, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 126, 127, 128, 129, 130, 131, 136, 137, 138, 139, 140, 141, 142, 143, 145, 146, 147, 148.

C. I. Disperse Red 1, 2, 3, 4, 5, 5:1, 6, 7, 8, 9, 10, 11, 12, 13, 14, 15, 16, 17, 18, 19, 20, 21, 22, 23, 24, 25, 26, 27, 28, 29, 30, 30:1, 31, 32, 33, 34, 35, 36, 38, 39, 40, 41, 43, 43:1, 46, 48, 50, 51, 52, 53, 54, 55, 55:1, 56, 58, 59, 60, 61, 63, 65, 66, 69, 70, 72, 73, 74, 75, 76, 77, 79, 80, 81, 82, 84, 85, 86, 86: 1, 87, 88, 89, 90, 91, 92, 93, 94, 96, 97, 98, 100, 102, 103, 104, 105, 106, 107, 108, 109, 110, 111, 112, 113, 115, 116, 117, 118, 120, 121, 122, 123, 125, 126, 127, 128, 129, 130, 131, 132, 133, 134, 135, 136, 137, 138, 139, 140, 141, 142, 143, 144, 145, 146, 147, 148, 149, 150, 151, 151:1, 152, 153, 154, 155, 156, 157, 158, 159, 160, 161, 162, 163, 164, 165, 166, 167, 167:1, 168, 169, 170, 171, 172, 173, 174, 175, 176, 177, 178, 179, 180, 181, 182, 183, 184, 185, 186, 187, 188, 189, 190, 190:1, 191, 191:1, 192, 193, 194, 195, 211, 223, 273, 274, 275, 276, 277, 278, 279, 280, 281, 302:1, 305, 306, 307, 308, 309, 310, 311, 312, 313, 314, 315, 316, 317, 318, 319, 320, 321, 322, 323, 324, 325, 326, 327, 328 329, 330, 331, 332, 333, 334, 335, 336, 338, 339, 340, 341, 342, 343, 344, 346, 347, 348, 349, 356, 367.

C. I. Disperse Violet 1, 2, 3, 4, 4:1, 5, 6, 7, 8, 9, 10, 11, 12, 13, 14, 15, 16, 17, 18, 19, 20, 21, 22, 23, 24, 25, 26, 27, 28, 29, 31, 33, 34, 35, 36, 37, 38, 39, 40, 41, 42, 43, 44, 45, 46, 47, 48, 49, 50, 51, 52, 53, 54, 55, 56, 57, 58, 59, 60, 81, 86, 87, 88, 89, 91, 92, 93, 94, 95, 96, 97.

C. I. Disperse Blue 1, 1:1, 2, 3, 3:1, 4, 5, 6, 7, 7:1, 8, 9, 10, 11, 12, 13, 13:1, 14, 15, 16, 17, 18, 19, 20, 21, 22, 23, 23:1, 24, 25, 26, 27, 28, 29, 30, 31, 32, 33, 34, 35, 36, 38, 39, 40, 42, 43, 44, 45, 47, 48, 49, 51, 52, 53, 54, 55, 56, 58, 60, 60:1, 61, 62, 63, 64, 64:1, 65, 66, 68, 70, 72, 73, 75, 76, 77, 79, 80, 81, 81:1, 82, 83, 84, 85, 86, 87, 88, 89, 90, 91, 92, 93, 94, 95, 96, 97, 98, 99, 100, 101, 102, 103, 104, 105, 106, 107, 108, 109, 111, 112, 113, 114, 115, 116, 117, 118, 119, 121, 122, 123, 124, 125, 126, 127, 128, 130, 131, 132, 133, 134, 136, 137, 138, 139, 140, 141, 142, 143, 144, 145, 146, 147, 148, 149, 150, 151, 152, 153, 154, 155, 156, 158, 159, 160, 161, 162, 163, 164, 165, 165:2, 166, 167, 168, 169, 170, 171, 172, 173, 174, 175, 195, 281, 282, 283, 283:1, 284, 285, 286, 287, 288, 289, 290, 291, 292, 293, 294, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 349.

C. I. Disperse Green 1, 2, 5, 6, 9.

C. I. Disperse Brown 1, 2, 3, 4, 4:1, 5, 7, 8, 9, 10, 11, 18, 19, 20, 21.

C. I. Disperse Black 1, 3, 4, 5, 6, 7, 8, 9, 10, 11, 12, 13, 14, 15, 20, 22, 24, 25, 26, 27, 28, 29, 29:1, 30, 31, 32, 33, 34, 36.

or a solvent dye from the following Colour Index List:

C. I. Solvent Yellow 2, 3, 7, 12, 13, 14, 16, 18, 19, 21, 25, 25:1, 27, 28, 29, 30, 33, 34, 36, 42, 43, 44, 47, 56, 62, 72, 73, 77, 79, 81, 82, 83, 83:1, 88, 89, 90, 93, 94, 96, 98, 104, 107, 114, 116, 117, 124, 130, 131, 133, 135, 141, 143, 145, 145, 146, 157, 160:1, 161, 162, 163, 167, 169, 172, 174, 175, 176, 179, 180, 181, 182, 183, 184, 185, 186, 187, 189, 190, 191.

C. I. Solvent Orange 1, 2, 3, 4, 5, 7, 11, 14, 20, 23, 25, 31A 40:1, 41, 45, 54, 56, 58, 60, 62, 63, 70, 75, 77, 80, 81, 86, 99, 102, 103, 105, 106, 107, 108, 109, 110, 111, 112, 113.

C. I. Solvent Red 1, 2, 3, 4, 8, 16, 17, 18, 19, 23, 24, 25, 26, 27, 30, 33, 35, 41, 43, 45, 48, 49, 52, 68, 69, 72, 73, 83:1, 84:1, 89, 90, 90:1, 91, 92, 106, 109, 111, 118, 119, 122, 124, 125, 127, 130, 132, 135, 141, 143, 145, 146, 149, 150, 151, 155, 160, 161, 164, 164:1, 165, 166, 168, 169, 172, 175, 179, 180, 181, 182, 195, 196, 197, 198, 207, 208, 210, 212, 214, 215, 218, 222, 223, 225, 227, 229, 230, 233, 234, 235, 236, 238, 239, 240, 241, 242, 243, 244, 245, 247, 248.

C. I. Solvent Violet 2, 8, 9, 11, 13, 14, 21, 21:1, 26, 31, 36, 37, 38, 45, 46, 47, 48, 49, 50, 51, 55, 56, 57, 58, 59, 60, 61.

C. I. Solvent Blue 2, 3, 4, 5, 7, 18, 25, 26, 35, 36, 37, 38, 43, 44, 45, 48, 51, 58, 59, 59:1, 63, 64, 67, 68, 69, 70, 78, 79, 83, 94, 97, 98, 99, 100, 101, 102, 104, 105, 111, 112, 122, 124, 128, 129, 132, 136, 137, 138, 139, 143.

C. I. Solvent Green 1, 3, 4, 5, 7, 28, 29, 32, 33, 34, 35.

C. I. Solvent Brown 1, 3, 4, 5, 12, 20, 22, 28, 38, 41, 42, 43, 44, 52, 53, 59, 60, 61, 62, 63.

C. I. Solvent Black 3, 5, 5:2, 7, 13, 22, 22:1, 26, 27, 28, 29, 34, 35, 43, 45, 46, 48, 49, 50.

or one of the following disperse dyes, which have no Colour Index:

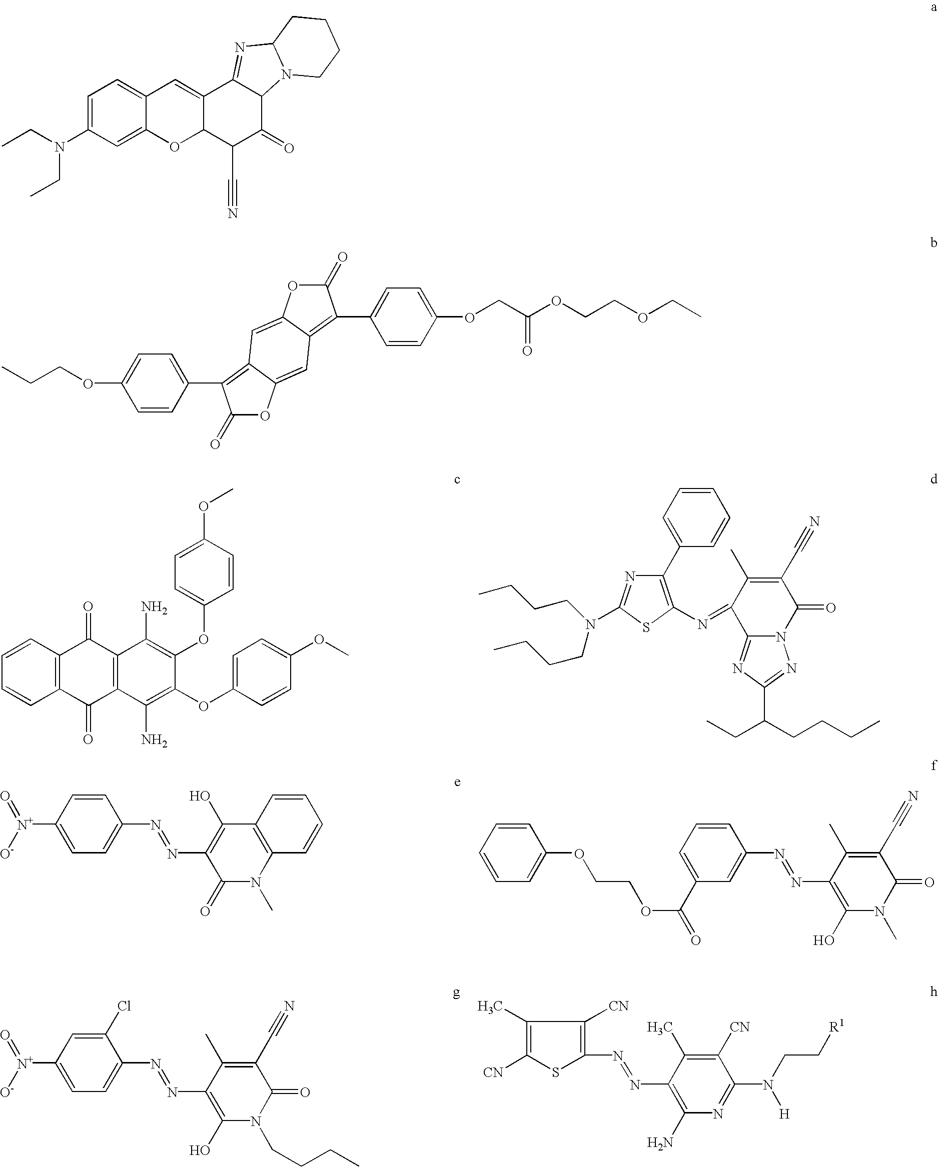

where

R¹ is preferably (CH₂)ₙ—O—(CH₂)ₘ—O—R², n is 0 or 1, m is an integer from 2 to 4 and R² is H or COCH₃. The dye h can be a single component or a mixture of compounds having the general structure h.

The colorant is advantageously first converted into a colorant paste with the dispersant. The colorant pastes are then used for producing the ready-to-use colorant preparation (inkjet ink). The colorant, for example in the form of an aqueous presscake or in the form of a dry colorant powder, is mixed together with the dispersant in the presence or absence of a diluent, such as water. The mixture obtained is subsequently ground in a mill to obtain the desired colorant particle size distribution. Particularly useful mills are bead mills, including double cylinder bead mills, or centrifugal fluidized bed mills. Finally, the preparation is end-standardized by adding appropriate amounts of water with or without further assistants to it. This is advantageously followed by filtration through a fine sieve or a filter, for example having a pore size of from 0.5 to 10 μm.

The median size of the colorant particles is generally in the range from 5 nm to 1 μm, especially in the range from 5 nm to 0.5 μm (the median particle size referred to being the x₅₀ value measured by quasi-elastic light scattering, cf. Bruce, J. Berne and Robert Pecora, Dynamic Light Scattering, John Wiley & Sons Inc. 1976, p. 169f).

The colorant preparations used according to the invention generally include from 0.1 to 20% by weight, preferably from 0.2 to 10% by weight, of colorant. They generally include from 0.1 to 20% by weight, preferably from 0.5 to 10% by weight, of dispersant. Water constitutes the main ingredient of the colorant preparations used according to the invention. The water content is generally in the range from 35 to 90% by weight, preferably in the range from 45 to 80% by weight.

The colorant preparations preferably further include a humectant. Useful humectants include polyhydric alcohols containing in particular from 3 to 8 carbon atoms, such as glycerol, erythritol, pentaerythritol, pentitols such as arabitol, adonitol and xylitol, hexitols such as sorbitol, mannitol and dulcitol. Useful humectants further include polyalkylene glycols and polyalkylene glycol monoalkyl ethers, especially having an average molecular weight of from 100 to 1500, particular preference being given to polyethylene glycols and polyethylene glycol ethers having an average molecular weight of less than 800. Examples thereof are di-, tri- and tetraethylene glycol, diethylene glycol monomethyl, monoethyl, monopropyl and monobutyl ether and trimethylene glycol monomethyl, monoethyl, monopropyl and monobutyl ether. Useful humectants further include pyrrolidones and N-alkylpyrrolidones, such as N-methylpyrrolidones. The fraction of humectant in the colorant preparations is generally in the range from 0 to 15% by weight. Useful humectants further include thioether analogs of several glycols.

The colorant preparations generally include further assistants such as preservatives, for example 1,2-benzisothiazolin-3-one and its alkali metal salts, glutaraldehyde or tetramethylolacetyleneurea; antioxidants; degassers/defoamers, such as acetylenediols and ethoxylated acetylenediols, which customarily contain from 20 to 40 mol of ethylene oxide per mole of acetylenediol; viscosity regulators, flow agents, wetters, anti-settlers, luster improvers, lubricants, adhesion improvers, antiskinning agents, delusterants, emulsifiers, stabilizers, hydrophobicizers, light control additives, hand improvers and antistats. When these assistants are part of the colorant preparations, their total amount is generally less than 1% by weight, based on the weight of the preparation.

The colorant preparations used according to the invention customarily have a viscosity of from 1 to 20 mm²/sec, preferably from 2 to 15 mm²/sec. The surface tension of the colorant preparations used according to the invention is generally from 20 to 70 mN/m. The pH is generally in the range from 5 to 11, preferably in the range from 6 to 10.

In the inkjet printing process, the aqueous colorant preparation is sprayed in small droplets directly onto the substrate. There is a continuous form of the inkjet process, in which the colorant preparation is uniformly pressed through a nozzle and the jet is directed onto the substrate by an electric field depending on the pattern to be printed, and there is an interrupted or drop-on-demand process, in which the ink is expelled only where a colored dot is to appear, the latter form of the process employing either a piezoelectric crystal or a heated canula (bubble or thermal jet process) to exert pressure on the ink system and so eject an ink droplet. These techniques are described in Text. Chem. Color, Vol. 19(8), p. 23-29, 1987, and Vol. 21(6), p. 27-32, 1989.

The colorant preparations used according to the invention may be printed on all types of substrate material. Useful substrate materials include for example

coated or uncoated cellulosics such as paper, paperboard, cardboard, wood and woodbase,

coated or uncoated metallic materials such as foils, sheets or workpieces composed of aluminum, iron, copper, silver, gold, zinc or alloys thereof,

coated or uncoated silicatic materials such as glass, porcelain and ceramics,

polymeric materials of any kind such as polystyrene, polyamides, polyesters, polyethylene, polypropylene, melamine resins, polyacrylates, polyacrylonitrile, polyurethanes, polycarbonates, polyvinyl chloride, polyvinyl alcohols, polyvinyl acetates, polyvinylpyrrolidones and corresponding copolymers and block copolymers, biodegradable polymers and natural polymers such as gelatin,

textile materials such as fibers, yarns, threads, knits, wovens, nonwovens and garments composed of polyester, modified polyester, polyester blend fabrics, cellulosics such as cotton, cotton blend fabrics, jute, flax, hemp and ramie, viscose, wool, silk, polyamide, polyamide blend fabrics, polyacrylonitrile, triacetate, acetate, polycarbonate, polypropylene, polyvinyl chloride, polyester microfibers and glass fiber fabrics,

leather—both natural and artificial—in the form of smooth leather, nappa leather or suede leather.

Alternatively, the images and patterns created by inkjet printing may first be applied to an intermediate substrate, for example a transfer paper, and applied to a second substrate, for example a textile substrate, by contacting the latter. This process frequently takes place at elevated temperature, for example at from 180 to 2200° C., in a press. The colorants sublime and diffuse into the second substrate.

To fix the print created on the substrate, a binder may be applied subsequently, if desired in the form of an aqueous dispersion or emulsion, and cured. Radiation-curable, thermally curable or air drying binders or physically drying binder dispersions or emulsions may be used. Examples of radiation-curable binders are monomers, prepolymers, polymers and blends thereof that contain acrylate groups, vinyl groups and/or epoxy groups.

Thermally curable binders are generally crosslinked via polycondensation or polyaddition reactions. Particularly useful thermally curable binders include for example polycondensation-crosslinking binders based on acrylates containing methylol groups.

Examples of air drying binders, where aliphatic double bonds are oxidatively crosslinked by the action of oxygen from air, are drying oils such as linseed oil, wood oil and safflower oil.

The invention is illustrated by the inventive and comparative examples hereinbelow.

The following dispersants were used:

D1 is a sulfonated lignin having a weight average molecular weight of 30500 and a polydispersity index of 8.8, wherein 56.5% by weight of all the molecules have a molecular weight of more than 10000.

D2 is a sulfonated lignin having a weight average molecular weight of 18100 and a polydispersity index of 9.6, wherein 40.0% by weight of all the molecules have a molecular weight of more than 10000.

D3 is an arylsulfonic acid-formaldehyde condensation product (as described for example in DE 197 54 025 and DE 197 27 766) having a weight average molecular weight of 5600 and a polydispersity index of 7.0, wherein 18.2% by weight of all the molecules have a molecular weight of more than 10000.

### Inventive Example 1

15 parts by weight of Solvent Yellow 163, 10 parts by weight of D1, 0.9 part by weight of biocide were ground in a DCP Superflow mill until the x₅₀ value was 0.44 μm. 35 parts by weight of the millbase were admixed with 15 parts by weight of diethylene glycol and 0.6 part by weight of biocide and made up with water to 100 parts by weight, mixed and filtered through a sieve having a pore size of 1 μm. There was virtually no residue left behind on the sieve. The ink had impeccable printing properties.

### Comparative Example 1

15 parts by weight of Solvent Yellow 163, 15 parts by weight of D2 and 0.9 part by weight of biocide were ground in a DCP Superflow mill until the x₅₀ value was 0.45 μm. 37 parts by weight of the millbase were admixed with 10 parts by weight of glycerol and 0.6 part by weight of biocide and made up with water to 100 parts by weight and filtered through a sieve having a pore size of 1 μm. A substantial residue remained behind on the sieve. The ink produced was not printable.

Comparative Example 1 was repeated by replacing the 10 parts by weight of glycerol with 10 parts by weight of 70% aqueous sorbitol solution. The same result was obtained.

### Inventive Example 2

15 parts by weight of a dye of the above-depicted structure h, 7.5 parts by weight of D1 and 0.9 part by weight of biocide were made up with water to 100 parts by weight and ground in a Tex mill until the x₅₀ value was 0.56 μm. 33 parts by weight of the millbase were admixed with 10 parts by weight of 70% aqueous sorbitol solution and 0.6 part by weight of biocide and made up with water to 100 parts by weight and filtered through a sieve having a pore size of 1 μm. The ink obtained had a viscosity of 2.08 mm²/sec and a surface tension of 48.1 mN/m.

### Comparative Example 2

15 parts by weight of a dye of the above-depicted structure h, 7.5 parts by weight of D2 and 0.9 part by weight of biocide were made up with water to 100 parts by weight and ground in a Tex mill until the x₅₀ value was 0.63 μm. A highly viscous, foaming millbase was obtained. 50 parts by weight of millbase, 10 parts by weight of 70% aqueous sorbitol solution and 0.6 part by weight of biocide were made up with water to 100 parts by weight and filtered through a sieve having a pore size of 1 μm. This ink obtained had a viscosity of 2.80 mm²/sec and a surface tension of 47.5 mN/m. The highly viscous and foaming ink had worse performance characteristics in inkjet printing than the ink of Inventive Example 2.

### Inventive Example 3

15 parts by weight of Disperse Blue 77, 15 parts by weight of D1 and 0.9 part by weight of biocide were ground in a DCP-SF mill until the x₅₀ value was 0.38. 34 parts by weight of millbase were admixed with 10 parts by weight of glycerol and 0.6 part by weight of biocide and made up with water to 100 parts by weight and filtered through a sieve having a pore size of 1 μm. There was no residue left behind on the sieve. The ink obtained had impeccable printing properties.

### Comparative Example 3

15 parts by weight of Disperse Blue 77, 7.5 parts by weight of D3, 15 parts by weight of diethylene glycol and 0.9 part by weight of biocide were ground in a Tex mill until the x₅₀ value was 0.43. The millbase was highly viscous and unsuitable for producing an ink.

### Inventive Example 4

15 parts by weight of C.I. Disperse Yellow 86, 10 parts by weight of D1, 10 parts by weight of diethylene glycol and 0.9 part by weight of biocide were made up with water to 100 parts by weight. The mixture was ground in a DCP-SF mill until the x₅₀ value was 0.43 μm. 39 parts by weight of millbase, 20 parts by weight of diethylene glycol were admixed with 0.6 part by weight of biocide and made up with water to 100 parts by weight and filtered through a sieve having a pore size of 1 μm. The ink obtained had a viscosity of 3.65 mm²/sec and a surface tension of 48.4 mN/m.

We claim:

1. The use of an aqueous colorant preparation including colloidally dispersed colorant particles and at least one dispersant selected from sulfonated and/or sulfomethylated lignins having a weight average molecular weight of not less than 25000 wherein more than 50% by weight of the molecules have a molecular weight of more than 10000, for printing sheetlike substrates by means of inkjet printing.

2. The use of claim 1, wherein the dispersant is selected from sulfonated and/or sulfomethylated lignins having a weight average molecular weight of more than 26000.

3. The use of claim 1 or 2, wherein the dispersant is selected from sulfonated and/or sulfomethylated lignins wherein more than 54% by weight of the molecules have a molecular weight of more than 10000.

4. The use of any of the preceding claims, wherein the dispersant is selected from sulfonated and/or sulfomethylated lignins having a polydispersity index PDI in the range from 7 to 11.

5. The use of any of the preceding claims, wherein the colorant is a disperse dye.

6. A process for printing sheetlike substrates, which comprises spraying an aqueous colorant preparation in droplets onto the substrate, the colorant preparation including colloidally dispersed colorant particles and at least one dispersant selected from sulfonated and/or sulfomethylated lignins having a weight average molecular weight of not less than 25000 wherein more than 50% by weight of the molecules have a molecular weight of more than 10000.

7. A method of producing a colorant preparation, which comprises grinding a colorant in the presence of a dispersant selected from sulfonated and/or sulfomethylated lignins having a weight average molecular weight of at least 25000 wherein more than 50% by weight of the molecules have a molecular weight of more than 10000 to form a millbase including colorant particles having a median particle size of less than 1 μm and diluting the millbase with water and optionally additional assistants to form a colorant preparation having a colorant content of from 0.1 to 20% by weight.

8. An aqueous colorant preparation useful for inkjet printing, including colloidally dispersed colorant particles having a median particle size of less than 1 μm and at least one dispersant selected from sulfonated and/or sulfomethylated lignins having a weight average molecular weight of not less than 25000 wherein more than 50% by weight of the molecules have a molecular weight of more than 10000.
